(19) United States
(12) Patent Application Publication
(10) Pub. No.: US 2008/0095568 A1
(43) Pub. Date: Apr. 24, 2008

(54) Shakable push button pen

(76) Inventor: Ming-Jen Hsien, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/448,093

(22) Filed: Jun. 7, 2006

(51) Int. Cl. B43K 24/00; B43K 24/03; B43K 24/08; B43K 7/12; B43K 5/16

(52) U.S. Cl. 401/115

(57) ABSTRACT

A shakable push button pen includes a stopping ring respectively disposed on outer circumferences of front end and rear end of an inner sleeve, a slidable load ring arranged between the two stopping rings, and a shaft extending backwards, assembled with a ratchet on rear end of the inner sleeve. The shaft inserting through an inner hole of a ratchet on the button is threaded with a sliding ring that is slidable inside the inner hole. When the pen is shaken forwards, the inner sleeve and the button are driven to slide forwards by momentum of the load ring that runs into the front stopping so as to make the refill extend or retract. Thus the push button pen can also be used as a shake pen.

### BACKGROUND OF THE INVENTION

The present invention relates to a shakable push button pen, especially to a pen that controls extension or retraction of the refill by pushing the button or shaking the pen forwards. The pen can be used as either a push button pen or a shaking pen.

There are various deigns of the retraction mechanism for pens. The most common one is push-button type, as shown from FIG. 1 to FIG. 4. The push-button type pen consists of an outer pen tube 10 with a plurality of guiding slots 101 on inner part of rear end thereof, a button 11 with ratchet 111 on front end thereof, an inner sleeve 12 with ratchet 121 on rear end thereof, a refill 13 inserted inside the inner sleeve 12 and a compression spring 14 on front end of the refill 13. While knocking the button 11, the ratchet 111 on front end slides along the guiding slots 101 linearly, pressing against and pushing the ratchet 121 as well as the inner sleeve 12 moving forwards. When the ratchet 121 moves over the front end of the guiding slots 101, the inner sleeve 12 as well as the ratchet 121 rotates synchronously a small angle by the design of the ratchet 111, 121 and backwards restoring force of the compression spring 14. And the ratchet 121 slides backward a small distance, then being locked on front end of the corresponding guiding slot 101. Now a head end of the refill 13 extends out the outer pen tube 10, ready fro writing, as shown in FIG. 2.

Next press the button 11 again, the ratchet 111 moves linearly along the guiding slots 101 and pushes the ratchet 121 as well as the inner sleeve 12 moving forwards. When the ratchet 121 moves over the front end of the guiding slots 101 again, the inner sleeve 12 as well as the ratchet 121 rotates synchronously a small angle. Thus the original stopping point of the ratchet 121 rolls out of the front end of the guiding slots 101 and then the guiding slots 101 turn into the connecting slot without any stopping point on the ratchet 121. Now by spring force of the compression spring 14, the inner sleeve 12, the refill 13 and the button are all slides backwards into a retracted status, as shown in FIG. 1, the refill 13 is retracted by pressing the button 11.

By the spring force of the compression spring 14, the inner sleeve 12, the refill 13 and the button 11 all slide backward, being retracted. Thus the refill 13 is retractable by the push button mechanism.

Moreover, there are shake pens disclosed in U.S. Pat. No. 6,923,588 B1 and U.S. Pat. No. 6,921,224 B1 that is ready to write by shake the pen tube. However, the push-button pens or shake pens mentioned above can't satisfy users' demands for innovation and change.

### SUMMARY OF THE INVENTION

Therefore it is a primary object of the present invention to provide a shakable push-button type pen that includes a stopping ring respectively disposed on outer circumferences of front end and rear end of an inner sleeve, a slidable load ring arranged between the two stopping rings. A shaft extending backwards is assembled with a ratchet on rear end of the inner sleeve. The shaft inserting through an inner hole of a ratchet on the button is threaded with a sliding ring that is slidable inside the inner hole. By pressing the button or shaking the pen tube, the refill is retractable. The present invention has both advantages of knock-on pen and shake pen.

### BRIEF DESCRIPTION OF THE DRAWINGS

FIG. 1 is a perspective view of a conventional push button pen while a refill retracts;

FIG. 2 is a perspective view of the embodiment in FIG. 1 while the refill extends;

FIG. 3 is an explosive view of the embodiment in FIG. 1;

FIG. 4 is a lateral cross sectional view of the embodiment in FIG. 1;

FIG. 5 is an explosive view of an embodiment in accordance with the present invention;

FIG. 6 is a lateral cross sectional view of the embodiment in accordance with the present invention while the refill retracts;

FIG. 7 is a partial enlarged view of the embodiment in FIG. 6;

FIG. 8 is a lateral cross sectional view of the embodiment in accordance with the present invention while the refill extends;

FIG. 9 is partial enlarged view of the embodiment in FIG. 8;

FIG. 10 is a lateral cross sectional view of another embodiment in accordance with the present invention.

### DETAILED DESCRIPTION OF THE PREFFERED EMBODIMENT

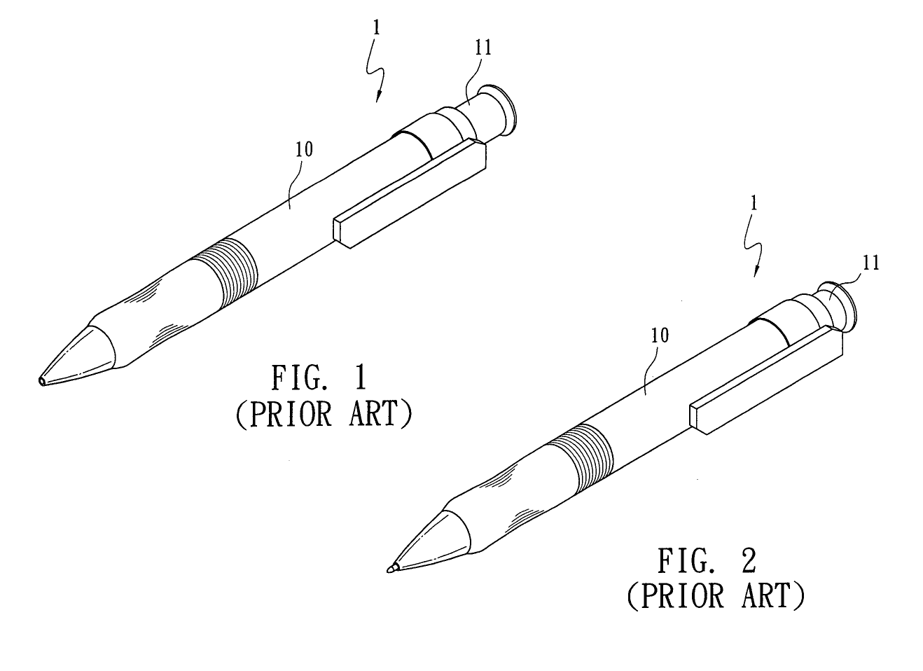

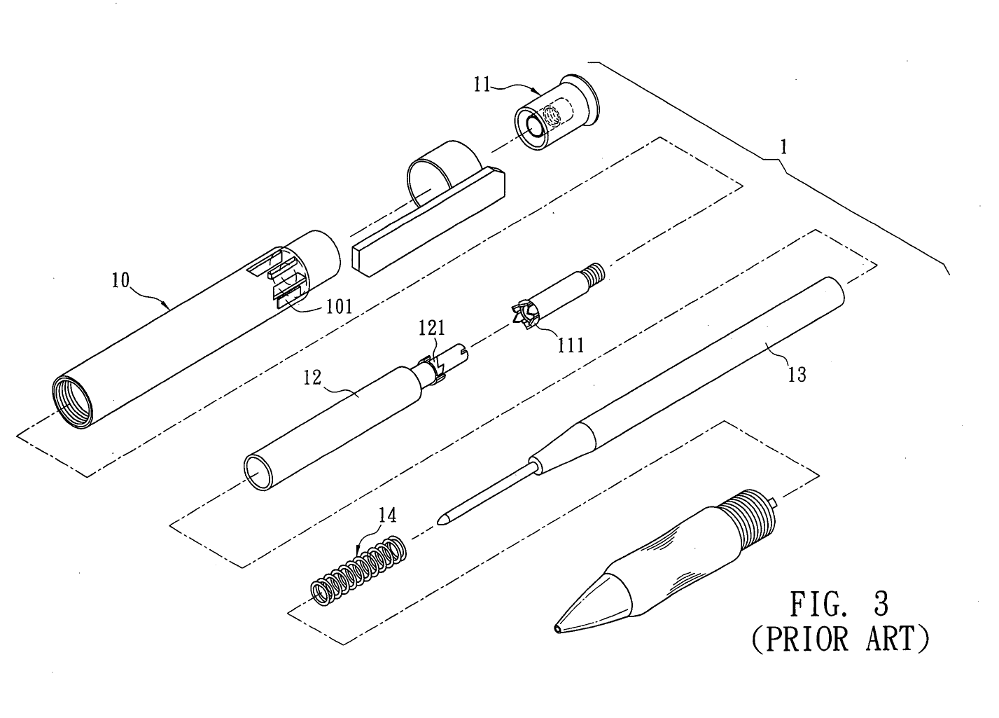

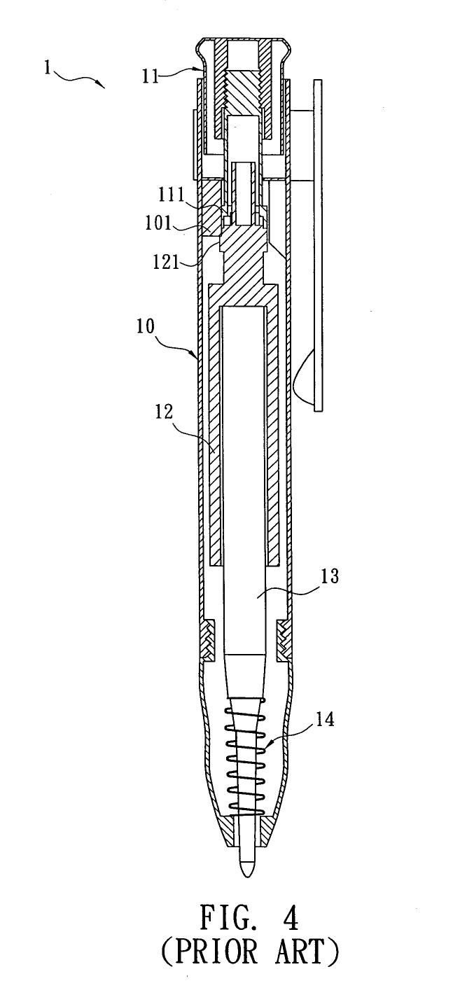

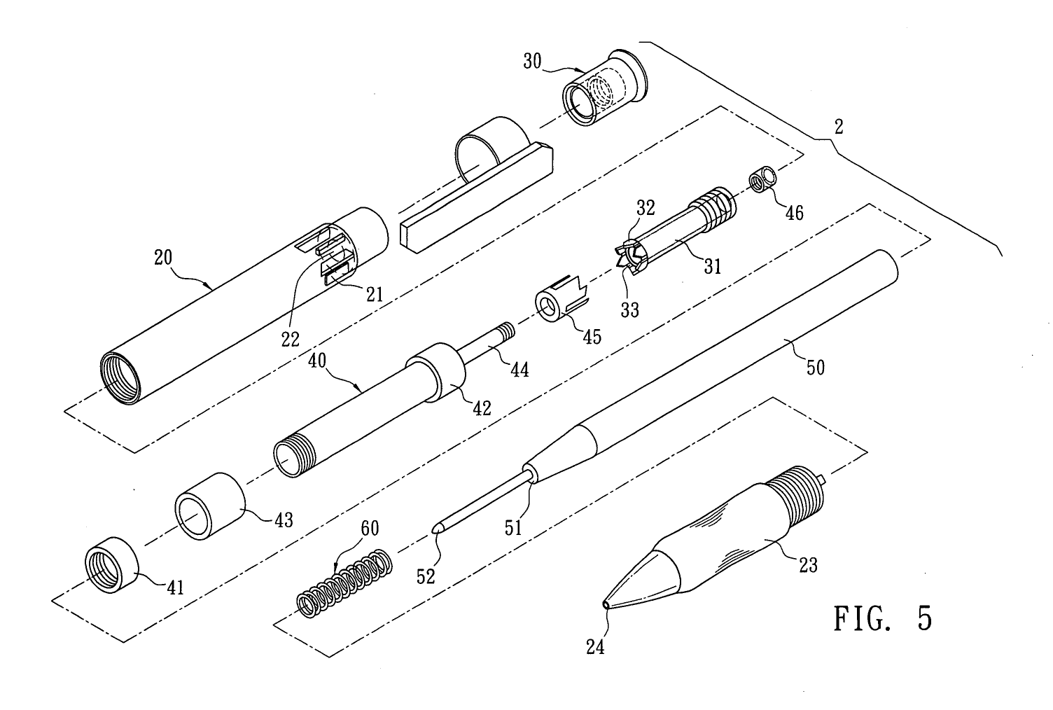

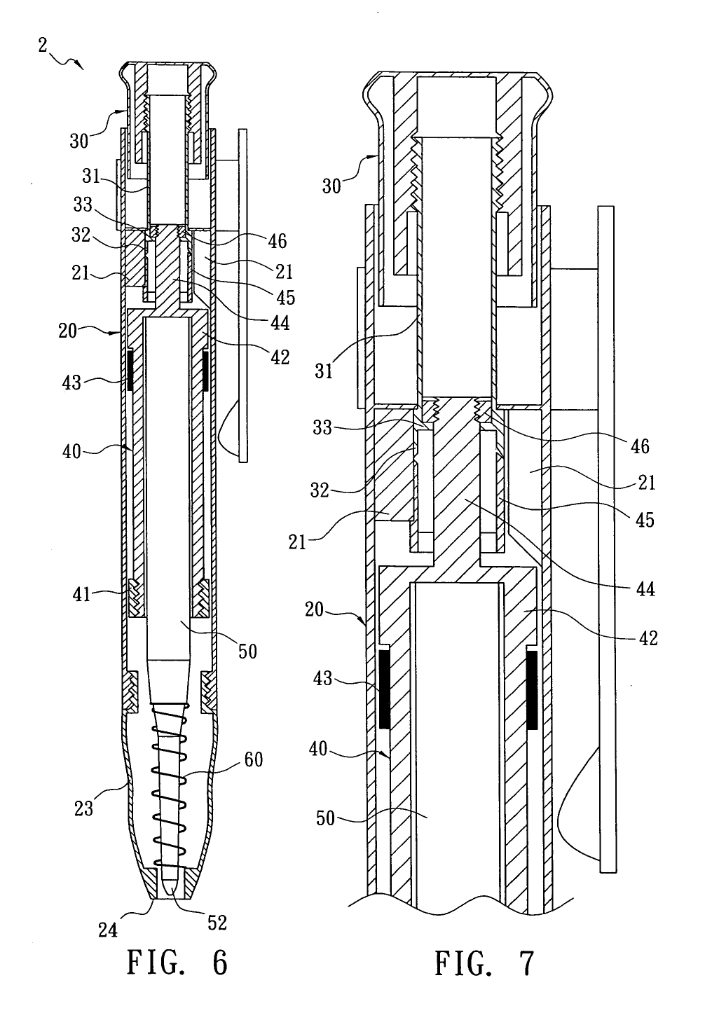

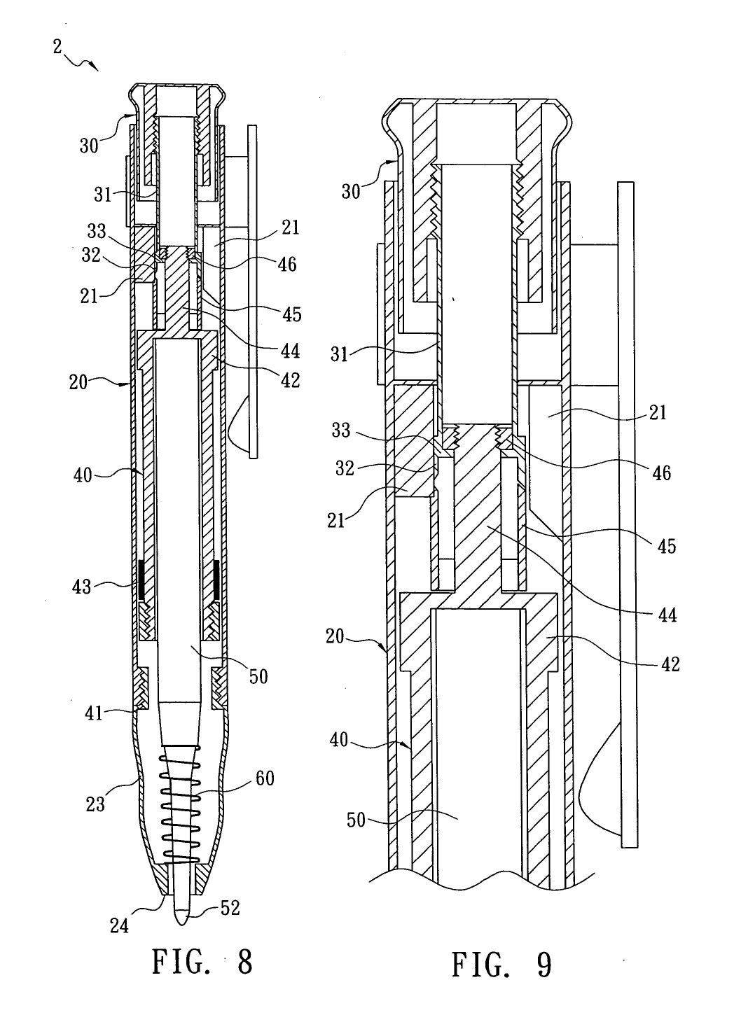

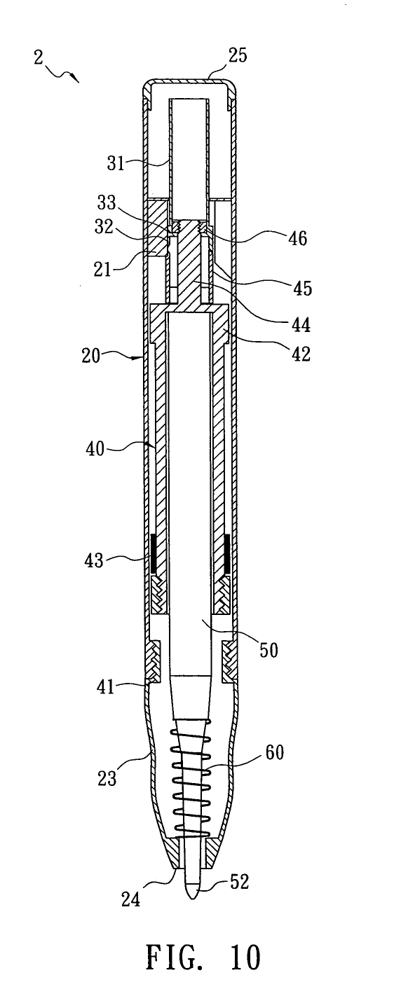

Refer from FIG. 5 to FIG. 9, a push button pen 2 is composed of an outer pen tube 20, a button 30, an inner tube 40, a refill 50 and a compression spring 60. The style of the present invention is similar to conventional push button pen 1 shown in FIG. 1 & FIG. 2. A plurality of guiding slots on the circumference 21 and a central hole 22 are disposed inside a tail end of the outer pen tube 20. The button 30 is a tube threaded with a hollow tube 31 that inserts through the front end of the outer pen tube 20 and the central hole 22.

Moreover, a ratchet 32 with diameter a bit larger than the diameter of the hollow tube 31 is disposed on circumference of the front end of the hollow tube 31. A flange 33 with diameter smaller than that of the hollow tube is arranged on inner surface of the ratchet 32. On outer circumferences of front end and rear end of an inner sleeve 40, respectively mount a stopping ring 41, 42 while a load ring 43 slidable on the inner sleeve 40 is arranged between the two stopping rings 41, 42. The load ring 43 is made from metal such as cooper or iron with certain weight. Furthermore, a shaft 44 extending outwards with a ratchet 45 outside is set on rear end of the inner sleeve 40. The ratchet 45 can be integrated with the shaft 44 or be an independent element assembled with the shaft 44, as shown in FIG. 5.

The ratchet 45 matches the ratchet 32 on the button 30. The shaft 44 inserts through the flange 33 on inner surface of the front end of the hollow tube 31, threaded with a sliding ring 46 so that the shaft 44 and the sliding ring 46 slide freely inside the hollow tube 31 without falling off from the front end thereof. In other words, when the shaft 44 moves forwards along with the inner sleeve 40, the sliding ring 46 firstly stops by the flange 33 of the hollow tube 31. Then the hollow tube 31 is forced to move forward together with the button 30. The refill 50 is mounted inside the inner sleeve 40 and the front end of the refill 50 is loaded into the compression spring 60. After the outer pen tube 20 being assembled with a front half tube 23, one end of the compression spring 60 presses against an inner surface of the front half tube 23 while the other end elastically presses against the refill 50 so as to make the refill 50 along with the inner sleeve 40 and the ratchet 45 all against the ratchet 32 for providing the button 30 restoring spring force during knocking on process.

In usage, by pressing the button 30 repeatedly, the refill 50 of the push button pen 2 according to the present invention is retractable. The pressing operation of the present invention is similar to that of general push button pen 1. Between the button 30 and the inner sleeve 40, the two corresponding ratchets 32, 45 moves elastically by spring force of the compression spring 60 and in combination with the guiding slots 21 on rear end of the outer pen tube 20, a nib 52 of the refill 50 extends out or retracts into a head 24 of the front half tube 23 of the outer pen tube 20 as shown in FIG. 1 & FIG. 2. As to the interaction between the ratchets 32, 45, with the guiding slots 21 inside the read end of the outer pen tube 20, it is similar to the way mentioned above.

By shaking forwards, the refill 50 of the push button pen 2 according to the present invention extends or retracts. No matter the refill 50 retracted (in FIG. 1) or extended (in FIG. 2), put the button 30 downwards so as to make the load ring 43 slides downwards to the rear stopping ring 42 and then shake the push button pen 2 forwards. The shake here means that user's hand moves a certain distance quickly and then stops immediately. By shaking force, the load ring 43 slides forwards rapidly from the rear stopping ring 42 to the stopping ring 41 of the inner sleeve 40. Due to inertia and momentum of the load ring 43, the inner sleeve 40 along with the refill 50 and the hollow tube 31 along with the button 30 are driven to slide forward. Thus each time of shaking has the same effect as pressing the button 30. The nib 52 of the refill 50 extends out or retracts into a head 24 of the front half tube 23, as shown in FIG. 1 & FIG. 2. Therefore, the push button pen 2 can also be used in shaking way.

Refer to FIG. 10, the button of the push button pen 2 according to the present invention can be removed. A cap 24 is fixed on rear end of the outer pen tube 20 so that the present invention can only be used as a shake pen. This depends on requirement of clients.

What is claimed is:

1. A shakable push button pen comprising an outer pen tube, a button, an inner sleeve, a refill and a compression spring, wherein
the outer pen tube having a front half tube, a plurality of guiding slots on circumference and a central hole are disposed inside a tail end thereof;
the button is a tube threaded with a hollow tube that inserts through the front end of the outer pen tube and the central hole; a ratchet with diameter a bit larger than the diameter of the hollow tube is disposed on circumference of the front end of the hollow tube while a flange with diameter smaller than that of the hollow tube is arranged on inner surface of the ratchet;
the inner sleeve having a stopping ring on outer circumferences of front end and rear end thereof respectively, a load ring slidable on the inner sleeve is arranged between the two stopping rings, a shaft extending outwards and a ratchet outside the shaft moving along with the ratchet of the button; the shaft inserts through the flange on inner surface of the front end of the hollow tube, threaded with a sliding ring so that the shaft and the sliding ring slide freely inside the hollow tube without falling off from the front end of the hollow tube;
the refill is mounted inside the inner sleeve;
the compression spring is disposed between a recess on front end of the refill and an inner surface of the front half tube of the outer pen tube;
when the button is pressed repeatedly, a nib of the refill extends out or retracts into a head of the outer pen tube by movement of corresponding ratchets on the button and the inner sleeve, as well as a plurality of guiding slots inside the outer pen tube; when the pen is shaken forwards, the inner sleeve, the refill, the hollow tube and the button are all driven to slide forwards by momentum of the load ring so as to make the nib of the refill extends out or retracts into the head of the outer pen tube.

2. The pen as claimed in claim 1, wherein the load ring is made from metal such as cooper or iron.

3. The pen as claimed in claim 1, wherein the front stopping ring is threaded and fixed on the inner sleeve by screw threads so that the load ring is disposed between the two stopping rings.

4. The pen as claimed in claim 1, wherein the ratchet on rear end of the inner sleeve is integrated into the shaft.

5. The pen as claimed in claim 1, wherein the ratchet on rear end of the inner sleeve is an independent part, being mounted on the shaft.

6. The pen as claimed in claim 1, wherein the button is replaced by a cap that is fixed on rear end of the outer pen tube while the rear end of the hollow tube is not threaded with the cap.
